(19) United States
(12) Patent Application Publication
(10) Pub. No.: US 2026/0201932 A1
(43) Pub. Date: Jul. 16, 2026

(54) ELECTROMECHANICAL BRAKING DEVICE FOR A MOTOR VEHICLE AND METHOD OF OPERATING AN ELECTROMECHANICAL BRAKING DEVICE

(71) Applicants: thyssenkrupp Presta AG, Eschen (LI); thyssenkrupp AG, Essen (DE)

(72) Inventors: Barna SZIMANDL, Gams (CH); Dennis PONGRATZ, Koblach (AT); Jan SLATINSKY, Buchs (CH)

(73) Assignees: thyssenkrupp Presta AG, Eschen (LI); thyssenkrupp AG, Essen (DE)

(21) Appl. No.: 19/136,416

(22) PCT Filed: Oct. 24, 2023
(86) PCT No.: PCT/EP2023/079630

§ 371 Date: Jun. 6, 2025

(30) Foreign Application Priority Data
Dec. 8, 2022 (BE) BE2022/5999

(51) Int. Cl. F16D 65/56; B60T 13/74; F16D 55/225; F16D 65/18; F16D 65/38; F16D 121/24; F16D 125/36; F16D 125/40; F16D 125/48

(52) U.S. Cl. CPC F16D 65/567; B60T 13/746; F16D 55/225; F16D 65/18; B60T 2270/402; F16D 2065/386; F16D 2121/24; F16D 2125/36; F16D 2125/40; F16D 2125/48

(57) ABSTRACT

An electromechanical braking device for a motor vehicle comprises an actuating device and a brake part, which is connected thereto, is adjustable along an axis by the actuating device and can be brought into braking engagement with a counter-braking part, wherein the actuating device has a first actuating drive and a second actuating drive, which is coupled in series thereto, wherein the first actuating drive has a rotationally drivable first drive wheel and the second actuating drive has a rotationally drivable second drive wheel, which is coaxial to the first drive wheel, wherein a clutch device is arranged between the first drive wheel and the second drive wheel. Adjustment of the air gap may be improved by the clutch device being a friction clutch with a friction element, which is frictionally connectable to a counter-friction element during the engagement of the clutch.

### PRIOR ART

The invention relates to an electromechanical braking device for a motor vehicle, comprising an actuating device and a brake part, which is connected thereto, is adjustable along an axis by the actuating device and can be brought into braking engagement with a counter-braking part, wherein the actuating device has a first actuating drive and a second actuating drive, which is coupled in series thereto, wherein the first actuating drive has a rotationally drivable first drive wheel and the second actuating drive has a rotationally drivable second drive wheel, which is coaxial to the first drive wheel, wherein a clutch device is arranged between the first drive wheel and the second drive wheel.

Such braking device of a motor vehicle is designed as a friction brake, in which a brake part which is supported on the chassis and is fixed relative to the rotation of the wheel to be braked can be brought by means of an actuating device into braking engagement with a counter-brake part, which rotates with the wheel. During the braking engagement, friction contact is produced between the brake part and the counter-brake part, with the braking torque produced by friction being greater, the higher the adjustment force is which is exerted by the actuating device in the adjustment direction.

The disk brakes which are known in principle and in which the counter-brake part is formed by a brake disk, which rotates with the wheel and is axially surrounded on both sides by a caliper, are widespread. By means of at least one preferably linear actuating drive, which is axially supported on the caliper, a brake part, usually a brake pad, can be adjusted in an axial adjustment direction and thereby brought into friction contact with an axial side of the brake disk, wherein, during the braking engagement, the brake disk is frictionally clamped between the adjusted brake part and a further brake part, which is supported axially opposite the caliper.

A prerequisite for satisfactory functioning and a very precise brake response is that, in the unactuated state, a defined distance, the so-called air gap, is provided between the brake part and the counter-brake part in the adjustment direction. When the brake is actuated, the brake part is moved by the actuating device toward the counter-brake part perpendicularly to the air gap until the air gap is overcome and the friction contact is achieved such that the braking engagement is produced.

For a reproducible and very precise brake response during the driving mode, it is essential that, in the unactuated state, the air gap has a defined gap width, as measured in the axial adjustment direction. The gap width may increase over the course of the operation, for example due to wear of the brake pad, and has to be readjusted accordingly. For adjusting the air gap, it is known from DE 10 2017 123 266 A1 that the actuating drive has two actuating drives arranged in series in the adjustment direction. Each of the actuating drives has a drive-side drive element and an output-side output element, which is linearly adjustable relative thereto in the axial adjustment direction. For the realization of an adjustment movement, each drive element has a drive wheel, preferably a transmission wheel, such as a gearwheel or the like, which is rotationally drivable about its axis by an electric actuating motor. The rotation of the drive wheel is converted in the actuating drive in each case into a relative adjustment movement or an actuating stroke of the output element relative to the drive element in the axial adjustment direction. In the prior art in question, the two drive wheels of the first and second actuating drive are arranged coaxially on a common axis lying in the axial adjustment direction.

An actuating drive in each case forms a lifting or adjusting device that is axially effective in the adjustment direction. For example, an actuating drive may have a spindle drive, in which the drive element has a spindle nut and the output element a threaded spindle engaging therein, or vice versa. It is also possible to use other designs of actuating drives which may comprise, for example, ramp bearings, cam disks, tilting pin arrangements or the like, and likewise convert rotation of the drive element into a linear adjustment of the output element.

Owing to the fact that the drive element of the second actuating drive is coupled to the output element of the first actuating drive, and the brake element is attached to the output element of the second actuating drive, the brake element can be adjusted linearly together with the second actuating drive by actuation of the first actuating drive, in order to produce the braking engagement. The air gap can be adjusted by adjustment of the second actuating drive independently of the actuation of the first actuating drive. The first actuating drive can therefore be operated continuously in the optimum working range.

Another advantage of the two coupled actuating drives is that a redundant design is possible. For example, the second actuating drive used during normal operation only to adjust the air gap can in principle also produce the braking engagement.

In order to permit synchronous rotation of the first and second drive elements during normal operation, so that the second actuating drive is carried along as a whole and is not adjusted, it has been proposed in the aforementioned DE 10 2017 123 266 A1 to provide a detent clutch between the first and second drive wheel. As a result, the two drive wheels can be coupled in separate latching stages, which are latchable with a releasable form fit, thus enabling reliable transmission of torque for the synchronization. However, the predetermined discrete latching stages also have to be overcome in order to adjust the air gap. A disadvantage of this is that only a gradual adjustment of the air gap is possible, as a result of which it is not satisfactorily possible to compensate for the continuous wear of the brake element. In addition, a relatively high driving torque is required to overcome the latching stages.

In view of the problems mentioned above, it is an object of the present invention to make an improved adjustment of the air gap possible.

### SUMMARY OF THE INVENTION

This object is achieved according to the invention by the braking device having the features of claim 1 and the method for operating the braking device according to claim 12. Advantageous developments are apparent from the dependent claims.

In the case of an electromechanical braking device for a motor vehicle, comprising an actuating device and a brake part, which is connected thereto, is adjustable along an axis by the actuating device and can be brought into braking engagement with a counter-braking part, wherein the actuating device has a first actuating drive and a second actuating drive, which is coupled in series thereto, wherein the first actuating drive has a rotationally drivable first drive wheel and the second actuating drive has a rotationally drivable second drive wheel, which is coaxial to the first drive wheel, wherein a clutch device is arranged between the first drive wheel and the second drive wheel, it is provided according to the invention that the clutch device is designed as a friction clutch with a friction element, which is frictionally connectable to a counter-friction element during the engagement of the clutch.

In the following text, the first and the second drive wheel together are also referred to as the two drive wheels or as the drive wheels for short.

The drive wheels can be designed as a gearwheel, for example as a spur gear, or as a belt wheel or toothed belt wheel or worm wheel, and therefore generally a transmission wheel is provided, via which a driving torque from an electric actuating motor can be coupled into the actuating drive.

According to the invention, a friction clutch is realized between the drive wheels. Said friction clutch comprises a friction element, which is connected torque-lockingly to one of the drive wheels, and a corresponding counter-friction element, which is connected torque-lockingly to the respective other drive wheel. The friction element can be brought into frictional coupling engagement with the counter-friction element in any relative angular position. In this case, a purely force-fit coupling is realized, unlike the form-fit latching connection in the prior art. As a result, the relative position of the drive wheels with respect to one another can be predetermined continuously, in contrast to the discrete latching stages in the prior art. Accordingly, a uniform, continuous adjustment of the second actuating drive relative to the first actuating drive is possible, and the air gap can be continuously adjusted. This is particularly advantageous with regard to uniform tracking of the optimum working point of the braking device to the continuous wear of the brake part during operation, i.e. the continuous wear of the brake pad. Compared to the only gradual adjustment option in the prior art, a continuously improved response behavior of the braking device can be realized and thus increased operational reliability and greater operating comfort.

Another advantage over a detent clutch described in the prior art is that, for actuating and re-leasing the clutch device, essentially no axial relative movement is required between the clutch elements involved in the engagement of the clutch, for example between the drive wheels or the latching elements, which clutch elements necessarily have to be movable with respect to one another in order to produce and release the latchable form fit. On the other hand, the pure force fit between the friction element and counter-friction element according to the invention can be simply predetermined by the applied axial actuation force, wherein the friction element and counter-friction element do not have to be moved axially relative to each other. This enables a simpler and more reliable structural design of the clutch device.

It is preferably provided that the friction clutch has a predeterminably defined clutch torque. The clutch torque specifies the maximum differential torque, which can be transmitted with a force fit between the friction element and the counter-friction element by the friction connection during the engagement of the clutch. When the clutch torque is exceeded, the clutch device slips such that the two drive wheels are rotated relative to each other. One advantage is that the friction clutch according to the invention continuously slidingly slips, and therefore an improved, uniform readjustment of the air gap is possible. In addition, no axial deviating movements of latching elements, as in the case of the known detent clutch, have to be taken into consideration structurally and absorbed.

It is advantageous that the friction element and the counter-friction element are arranged coaxially. The coaxial arrangement corresponds to the coaxial arrangement of the drive wheels. The friction element and the counter-friction element can be arranged structurally simply and in a compact design in the region of the axially oppositely directed end faces of the drive wheels. Owing to the above-described production of the pure force fit of the clutch, no moving parts whatsoever, as in the case of the detent clutch in the prior art, are required.

In an advantageous embodiment, it can be provided that the friction element and the counter-friction element are conical. The friction element can have a conical section at least partly con-verging in the axial adjustment direction and having a conical friction surface, which can be designed as an outer cone or inner cone, and which has a corresponding conical section on the counter-friction element, which is correspondingly designed in the opposite direction as an inner cone or outer cone and has a conical counter-friction surface. To produce the engagement of the clutch, the outer cone enters the inner cone, with the conical friction and counter-friction surfaces being loaded frictionally against each other by an axial actuation force of the clutch. One advantage is that the axially acting actuation force of the clutch can be converted by the cone into the normal force acting between the conical friction surfaces during the friction contact. Thus, a relatively small axial actuation force can be converted by a relatively shallow slope into a larger normal force in the friction contact, as a result of which a high clutch torque can already be realized by a relatively small axial actuation force of the clutch.

Alternatively or in addition to the above-mentioned embodiment, it can be provided that the friction element and the counter-friction element are planar. The mutually corresponding friction surfaces are at least partly designed as flat axial surfaces, similar to a disk clutch. A space-saving arrangement is made possible, especially if only a relatively small clutch torque is to be realized.

It can preferably be provided that the friction element and the counter-friction element are pre-loaded against each other. Preferably, the friction element and the counter-friction element are preloaded against each other elastically or resiliently. The friction and counter-friction surfaces are pressed against each other in the frictional connection by a predetermined axial preload force. In order to generate the preload force, an elastic preload element can preferably be provided, for example, a spring element or the like. The clutch torque of the friction clutch is determined by the actuation force acting perpendicular to the friction contact, i.e. the force applied axially between the friction and counter-friction element, with a greater preload force resulting in a larger clutch torque. This opens up the advantageous possibility of simply predetermining the clutch torque by the preload force exerted by the preload element. For example, in the case of a spring element which is flexible in the axial direction under pressure, such as a compression spring, the preload force exerted can be simply predetermined and adjusted by the spring constant and the compression of the spring.

The aforementioned embodiment can be advantageously realized in that the friction element and/or the counter-friction element are/is axially displaceable and supported against the first drive wheel or the second drive wheel via an axially effective spring element. The friction element or the counter-friction element are torque-lockingly and axially displaceably connected to the one drive wheel, for example via radially projecting drivers producing a form fit, which is effective in the circumferential direction. The spring element which is axially clamped between the friction element or the counter-friction element and the one drive wheel and is preferably designed as an axially effective compression spring ensures that the friction or counter-friction element is preloaded axially against the corresponding counter-friction or friction element, which is axially supported on the other drive wheel, i.e., is axially pressed against it during the friction contact. The corresponding counter-friction or friction element is connected to the respective other drive wheel for conjoint rotation. It is also possible that, alternatively or additionally, the counter-friction element is supported on one of the drive wheels via a spring element. One advantage of this arrangement is that the friction clutch according to the invention can be incorporated between the drive wheels in a simple and space-saving way.

In an advantageous development, it is possible that the friction element and/or the counter-friction element are/is arranged in the first drive wheel or the second drive wheel. For example, it is possible to design the drive wheel to be substantially drum-shaped, and therefore the friction or counter-friction element can be arranged in an interior space enclosed by the rotating gearwheel or gear rim. This permits a compact design which is protected against external influences. Thus, for example, the drive wheel of the first actuating drive can have a conical friction element which engages axially in a counter-friction element, which is designed as an inner cone and is at least partly arranged within the second drive wheel.

A particularly compact design can be realized—in particular in the last-mentioned embodiment—in that the drive wheels are arranged within the axial extent of the actuating drives, i.e., are not attached protruding axially on one side.

It is preferred that the friction element and/or the counter-friction element have/has a friction pad. The friction and counter-friction element preferably have a metallic basic body, for example made of steel. In order to avoid metal-to-metal contact, a coating or a pad for producing a friction pairing with a defined friction force can preferably be applied, for example, made of sintered materials, metal and/or ceramic friction materials, composite materials or the like. This can ensure a defined, reproducible clutch torque.

It can be provided that an actuating drive has a spindle drive. In this case, in a manner known per se, a threaded spindle engages in a spindle nut and a relative rotating drive via a drive wheel connected to the threaded spindle or the spindle nut. It is possible for the spindle nut to form the drive-side drive element of the actuating drive, and the threaded spindle the output-side output element, which is linearly adjustable relative thereto, or vice versa.

It is possible for an actuating drive to have a wedging disk arrangement, ball ramp arrangement or a tilting pin arrangement. In the case of a ball ramp arrangement, also referred to as ramp bearings, the drive and output elements preferably have cam disks with raceways or ramps which are inclined against the axis and between which balls which are rollable in the circumferential direction are arranged. Owing to the balls rolling on the ramps, a relative rotation causes the output element to be axially displaced relative to the drive element. In a tilting pin arrangement which is known per se, tilting pins are arranged between the drive element and output element and are each supported in the circumferential direction in such a way that, in the event of a relative rotation, they are inclined to a greater or lesser extent against the axis depending on the direction of rotation, as a result of which the distance between the drive element and output element is also adjustable.

In the actuating device, two identically acting actuating drives can be combined with each other as first and second actuating drives, for example, two spindle drives. It is also possible to combine two different designs together, for example, a ball ramp arrangement as the first actuating drive, and a spindle drive as the second actuating drive, for adjusting the air gap. The respective characteristic properties of each design can be optimally exploited. For example, a non-linear adjustment characteristic and/or at least partially self-locking properties, and/or a defined dead center or extended position, which permits a defined adjustment path, can be realized with little outlay using a ball ramp arrangement. The realization of the aforementioned positive properties may at least in some instances require the air gap to be precisely specified, which is not possible with the detent clutch in the prior art, but can be realized without any problems by means of the friction clutch according to the invention.

In a method for operating an electromechanical braking device which has an actuating device, comprising a first actuating drive and an actuating drive, which is coupled in series thereto, and which actuating device acts on a brake part, which can be brought into braking engagement with a counter-brake part in the direction of an axis, wherein the first actuating drive has a rotationally drivable first drive wheel, to which a first driving torque can be applied for the actuation, and the second actuating drive has a rotationally drivable second drive wheel, which is coaxial to the first drive wheel and to which a second driving torque can be applied for the actuation, wherein a clutch device is arranged between the first drive wheel and the second drive wheel, it is provided according to the invention that the clutch device is designed as a friction clutch and has a predeterminable clutch torque, in the event of the exceeding of which the first drive wheel slips slidingly relative to the second drive wheel, wherein, for the actuation of the first actuating drive, the first drive wheel and the second drive wheel are driven synchronously, and therefore the second actuating drive remains unactuated, and, for the actuation of the second actuating drive, the second drive wheel is driven, and the first drive wheel is stopped relative thereto such that the friction clutch slips and the first actuating drive remains unactuated.

The features mentioned above in conjunction with the braking device according to the invention can be used individually and in combinations for implementing the method according to the invention.

For adjusting the first actuating drive, an actuating torque can be coupled into the first drive wheel by means of a first electric actuating motor and, accordingly, the second actuating drive can be driven by a second electric actuating motor.

During the normal braking mode, the first and second drive wheels are rotated synchronously. This can take place, on the one hand, by the first and second drive wheels being driven by the first and second actuating motors with synchronized driving torques. On the other hand, the second drive wheel can be carried along synchronously by the clutch device during driving of the first drive wheel, as long as the transmitted driving torque remains under the clutch torque. In this operating mode, the second actuating drive remains unactuated and idly revolves as a whole together with the brake element.

In the method according to the invention, when the clutch torque is exceeded, in order to adjust the air gap, the clutch device can slip continuously and uniformly slidingly, in contrast to the prior art. This can be realized, for example, in that the drive wheel of the first actuating drive is fixed, for example by a brake or a corresponding activation of the first drive motor, while a second driving torque, which is greater than the clutch torque, is applied to the second drive wheel by the second drive motor. Thus, the second drive wheel is rotated relative to the first drive wheel and, by actuation of the second actuating drive, the air gap can be continuously and sensitively adjusted such that a continuously progressive wear of the brake element or the brake pad can be optimally compensated.

It is possible for the first drive wheel and the second drive wheel to be torque-lockingly coupled by the friction clutch to produce a synchronous drive.

In this case, synchronous driving of the two drive wheels by the actuating motors is not required. Any torque differences can be compensated within predetermined tolerances.

It can be advantageously provided that a higher clutch torque is specified when the first actuating drive is actuated than when the second actuating drive is actuated. The first actuating drive is actuated by synchronous driving of the first and second drive wheels. The friction element and the counter-friction element are preloaded against each other by the spring force of the spring element, and in addition, the adjustment force of the first actuating drive acts in opposition to the spring force. This results in a relatively high clutch torque. If, on the other hand, only the second drive wheel is rotated to adjust the air gap, the spring force alone is in action, and therefore a lower clutch torque is set. This makes it easier to adjust the air gap.

### DESCRIPTION OF THE DRAWINGS

Advantageous embodiments of the invention will be described in more detail below with reference to the drawings, in which, specifically:

FIG. 1 shows a schematic perspective view of a braking device according to the invention,

FIG. 2 shows a lateral view of the braking device according to FIG. 1,

FIG. 3 shows a detached schematic perspective view of the actuating device according to the invention of the braking device according to FIG. 1,

FIG. 4 shows a section Q-Q through the braking device according to FIG. 1,

FIG. 5 shows a detached schematic perspective illustration of the first actuating drive of the braking device according to FIG. 1,

FIG. 6 shows an enlarged detailed view of the actuating device from FIG. 4,

FIG. 7 shows an actuating device according to the invention in a second embodiment in a detailed view as in FIG. 4.

### EMBODIMENTS OF THE INVENTION

In the various figures, identical parts are always provided with the same reference signs, and will therefore generally also be named or mentioned only once in each case.

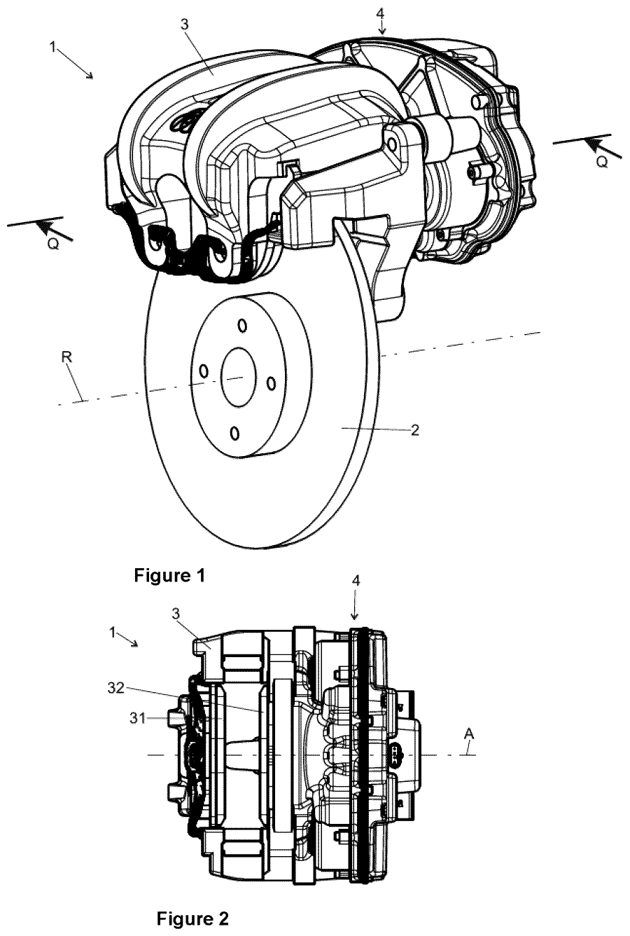

FIG. 1 shows a braking device according to the invention as a whole, in the form of a disk brake. It comprises a brake disk 2, which forms a counter-braking part within the meaning of the invention and is connected to a vehicle wheel, not illustrated here, which is rotatable about a wheel axis R. A brake caliper 3 engages around the two axial end faces of the brake disk 2.

The brake disk 2 is designed here as an unventilated brake disk made of solid material. Alternatively, it can also be designed as an internally ventilated brake disk.

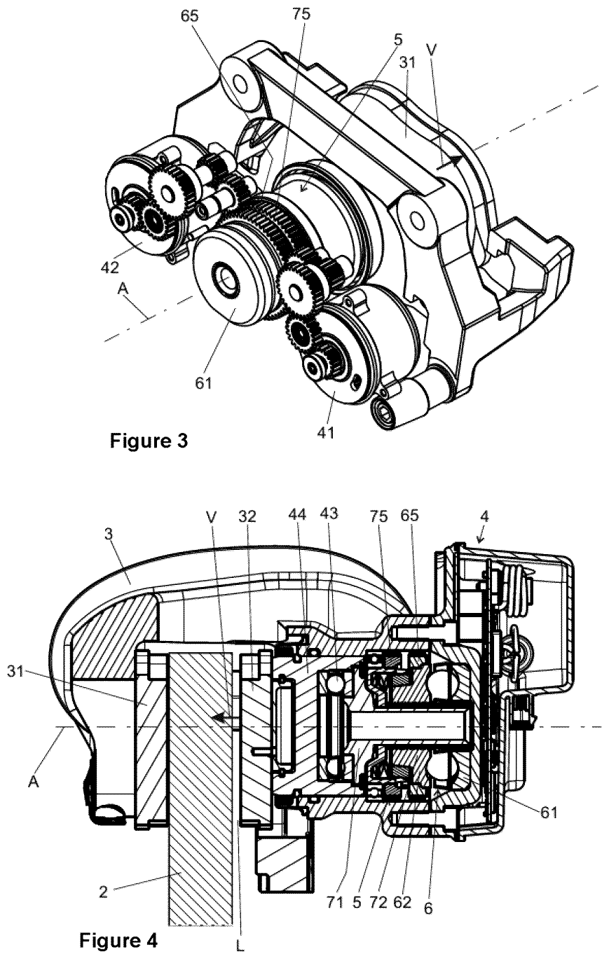

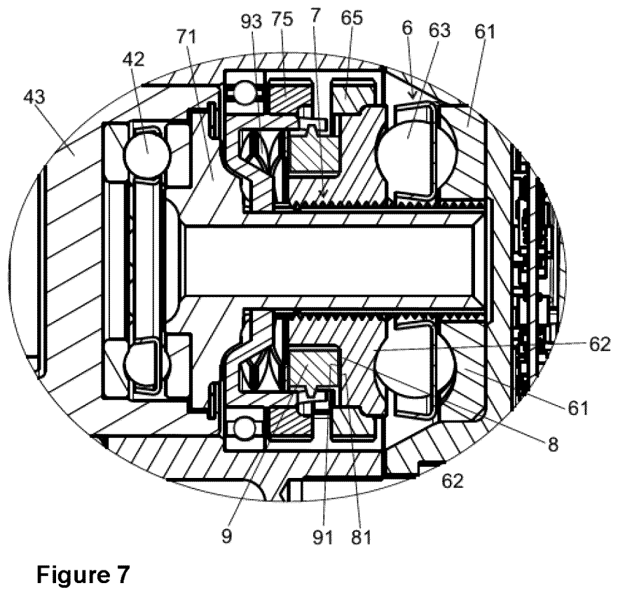

An electric brake actuator 4 according to the invention, which is shown in FIG. 3 in a separate, detached schematic perspective view, and is explained in detail in FIGS. 4 to 7, is attached to the brake caliper 3.

The brake actuator 4 comprises an actuating device 5 which extends axially in the direction of an axis A, which lies parallel to the wheel axis R and indicates the adjustment direction V of the actuating device 5.

As can be seen in the sectional illustration of FIG. 4 along the axis A, the brake disk 2 is arranged axially between two brake pads 31 and 32. The one brake pad 31 is fixedly supported on the brake caliper 3 on the side facing away from the brake actuator 4. The other brake pad 32, which forms a brake part within the meaning of the invention, is attached to the actuating device 5 and is adjustable by the latter in the axial adjustment direction V, indicated by the axis A, toward the brake disk 2 to produce the braking engagement, as indicated in FIG. 4 by the arrow.

In the unactuated state of the braking device 1, an axial air gap L, which is shown schematically with an exaggerated width in FIG. 4, is located between the brake disk 2 and the adjustable brake pad 32.

The construction of the actuating device 5 is illustrated in FIG. 4 and in the enlarged detail thereof in FIG. 6.

The actuating drive 5 comprises a first actuating drive 6, which has a ramp bearing, and a second actuating drive 7, which is coupled axially thereto in series (with respect to the axis A) and has a spindle drive.

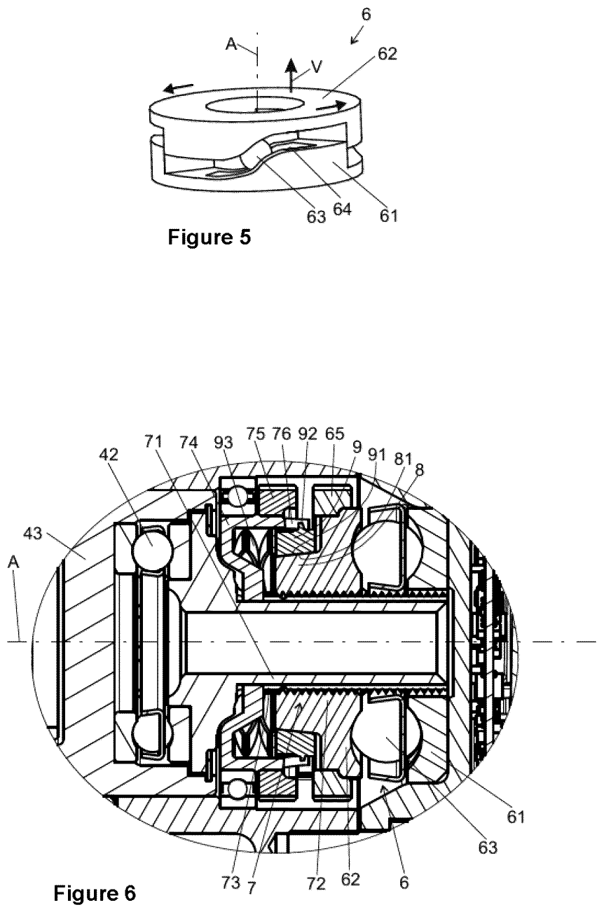

The first actuating drive 6, which is formed in the example shown as a ramp bearing, comprises a drive-side cam disk 61, which is supported axially on the brake actuator 4 for rotation therewith, and an output-side cam disk 62. Balls 63 are arranged between the cam disks 61 and 62. As can be seen in the schematically detached view of FIG. 5, the cam disks 61 and 62 have mutually axially opposite ramp-like raceways 64, which lie obliquely with respect to the axis A and between which balls 63 can roll. Rotation of the output-side cam disk 62, in FIG. 5 above, relative to the fixed drive-side cam disk 61—as schematically indicated by the curved arrows—leads to a linear adjustment of the output-side cam disk 62 in the adjustment direction V parallel to the axis A. Thus, as shown in FIG. 4, the brake pad 32 can be brought into braking engagement by actuation of the first actuating drive 6.

The cam disk 62 is connected to a coaxial gearwheel 65, which is in the form of a spur gear and forms a drive wheel within the meaning of the invention.

The gearwheel 65 is in transmission engagement with a first electric actuating motor 41. This enables the rotating drive of the cam disk 62 and thus actuation of the first actuating drive 6.

The second actuating drive 7, which in the example shown is in the form of a spindle drive, has, on the output side, a threaded spindle 71, which engages in the internal thread of a drive-side spindle nut 72. This internal thread is formed in the output-side cam disk 62 of the first actuating drive 6 such that the functions of the output-side cam disk 62 and the drive-side spindle nut 72 are combined in one component.

The threaded spindle 71 is connected via a hub part 74 to a coaxial gearwheel 75, which is rotatably mounted in axially fixed form in the brake actuator 4. The threaded spindle is torque-lockingly but axially displaceably coupled to the gearwheel 75 via drivers 73, which can have, for example, radially projecting protrusions or teeth, which engage axially movably in axial slots of the hub part 74.

The gearwheel 75, like the gearwheel 65, can be designed as a spur gear and is arranged coaxially adjacent to the latter. This gearwheel 75 is in transmission engagement with a second electric actuating motor 42. This enables the rotating drive of the threaded spindle 71 and thus actuation of the second actuating drive 7.

The threaded spindle 71 is axially connected via a thrust bearing 43, for example, as shown, an axial rolling bearing, to a thrust member 44 to which the displaceable brake pad 32 is attached, as can be seen in FIG. 4. The thrust member 44 may also be referred to as a piston.

The clutch device according to the invention has a friction element 8, which as a coaxial, conical shoulder, is directed from the cam disk 62 to the second actuating drive 7. The conical shoulder has a conical friction surface 81 arranged on the outside of an outer cone. The friction element 81 can preferably be formed integrally with the cam disk 62/spindle nut 72.

When the clutch is engaged, the friction element 8 is frictionally coupled to a counter-friction element 9. In this case, the conical shoulder axially enters a corresponding conical opening in the counter-friction element 9, which has a conical friction surface 91 arranged in an inner cone. When the clutch is engaged, the friction surface 81 and the counter-friction surface 91 lie frictionally against each other, as can be clearly seen in FIG. 6.

The counter-friction element 9 is torque-lockingly but axially displaceably coupled to the gearwheel 75 via drivers 92, which engage axially moveably in corresponding slots 76 in the hub part 74 or in the gearwheel 75.

A spring element 93 is arranged between the gearwheel 75 or the hub part 74, which is connected thereto, and the counter-friction element 9. Owing to its axially effective spring force, the counter-friction element 9 is elastically clamped against the friction element 8. A defined clutch torque of the friction clutch according to the invention formed by the friction element 8 and the counter-friction element 9 is produced as a result.

The second embodiment shown in the same view as in FIG. 6 differs by the formation and arrangement of the friction surface 81 and the counter-friction surface 91, both of which are designed as flat axial surfaces, in contrast to the conical surfaces of the first design according to the first embodiment shown in FIGS. 4 and 6. The operation is in principle identical and therefore the same reference signs are also used.

For actuation of the braking device 1, the gearwheels 65 and 75 are rotated synchronously such that the first actuating drive 6 performs a working stroke in the adjustment direction V, and therefore the brake pad 32 passes through the air gap L and comes into braking engagement with the brake disk 2. The synchronous driving of the gearwheels 65 and 75 can be achieved by synchronizing the drive speeds of the actuating motors 41 and 42, or by the drive being effected by only one of the actuating motors 41 or 42, while the respective other actuating motor 42 or 41 revolves idly. The frictional engagement of the clutch between the friction element 8 and the counter-friction element 9 then ensures synchronous rotation of the gearwheels 65 and 75.

To adjust the width of the air gap L, the gearwheel 65 is fixed or blocked, for example by corresponding activation of the first actuating motor 41. By means of the second actuating motor 42, the gearwheel 75 is rotated relative to the gearwheel 65, with the friction clutch continuously slidingly slipping. Accordingly, the second actuating drive 7 is uniformly adjusted, as a result of which the width of the air gap L can likewise be continuously set and adjusted, for example, to compensate for wear of the brake pad 32.

Owing to the fact that the friction element 8 and the counter-friction element 9 are arranged entirely or at least partially within the gearwheels 65 and 75, a particularly compact design can be realized.

The braking devices illustrated in FIGS. 1 to 7 are in the form of floating caliper brakes, also referred to as fist-type caliper brakes. In this case, the brake pad 32 is pressed by the thrust member 44, and the brake pad 31 by the brake caliper 3, which is movable in the direction of the axis A in relation to the brake disk 2, against the brake disk 2. Alternatively, the solution according to the invention can also be used for a fixed caliper brake.

### LIST OF REFERENCE SIGNS

1 Braking device
2 Brake disk
3 Brake caliper
31, 32 Brake pad
4 Brake actuator
41, 42 Actuating motor
43 Thrust bearing
44 Thrust member
5 Actuating device
6 First actuating drive
61 Cam disk
62 Cam disk (integrated with spindle nut 72)
63 Ball
64 Raceway
65 Gearwheel
7 Second actuating drive
71 Threaded spindle
72 Spindle nut (integrated with cam disk 62)
73 Driver
74 Hub part
75 Gearwheel
76 Slot
8 Friction element
81 Friction surface
9 Counter-friction element
91 Counter-friction surface
92 Driver
93 Spring element
A Axis
R Wheel axis
V Adjustment direction
L Air gap

1-14. (canceled)

15. An electromechanical braking device for a motor vehicle, comprising:
an actuating device; and
a brake part connected to the actuating device;
wherein the brake part is adjustable along an axis by the actuating device and can be brought into braking engagement with a counter-braking part;
wherein the actuating device has a first actuating drive and a second actuating drive coupled in series with the first actuating drive;
wherein the first actuating drive has a rotationally drivable first drive wheel and the second actuating drive has a rotationally drivable second drive wheel, which is coaxial to the first drive wheel;
wherein a clutch device is arranged between the first drive wheel and the second drive wheel;
wherein the clutch device is designed as a friction clutch with a friction element, which is frictionally connectable to a counter-friction element during the engagement of the clutch.

16. The braking device as claimed in claim 15, wherein the friction clutch has a predeterminably defined clutch torque.

17. The braking device as claimed in claim 15, wherein the friction element and the counter-friction element are arranged coaxially.

18. The braking device as claimed in claim 15, wherein the friction element and the counter-friction element are conical.

19. The braking device as claimed in claim 15, wherein the friction element and the counter-friction element are planar.

20. The braking device as claimed in claim 15, wherein the friction element and the counter-friction element are preloaded against each other.

21. The braking device as claimed in claim 20, wherein the friction element and/or the counter-friction element are/is axially displaceable and supported against the first drive wheel or the second drive wheel via an axially effective spring element.

22. The braking device as claimed in claim 20, wherein the friction element and/or the counter-friction element are/is arranged in the first drive wheel or the second drive wheel.

23. The braking device as claimed in claim 15, wherein the friction element and/or the counter-friction element have/has a friction pad.

24. The braking device as claimed in claim 15, wherein an actuating drive has a spindle drive.

25. The braking device as claimed in claim 15, wherein an actuating drive has a wedging disk arrangement, ball ramp arrangement or a tilting pin arrangement.

26. A method for operating an electromechanical braking device which has an actuating device, comprising a first actuating drive and a second actuating drive coupled in series to the first actuating drive, and which actuating device acts on a brake part, which can be brought into braking engagement with a counter-brake part in the direction of an axis, wherein the first actuating drive has a rotationally drivable first drive wheel, to which a first driving torque can be applied for actuation, and the second actuating drive has a rotationally drivable second drive wheel, which is coaxial to the first drive wheel and to which a second driving torque can be applied for the actuation, wherein a clutch device is arranged between the first drive wheel and the second drive wheel, wherein the clutch device is designed as a friction clutch and has a predeterminable clutch torque, in the event of the exceeding of which the first drive wheel slips slidingly relative to the second drive wheel, the method comprising:
driving the first drive wheel and the second drive wheel synchronously, thereby actuating the first actuating drive while the second actuating drive remains unactuated; and
driving the second drive wheel and stopping the first drive wheel relative to the second drive wheel such that the friction clutch slips, thereby actuating the second actuating drive while the first actuating drive remains unactuated.

27. The method as claimed in claim 26, wherein the first drive wheel and the second drive wheel are torque-lockingly coupled by the friction clutch to produce a synchronous drive.

28. The method as claimed in claim 26, wherein a higher clutch torque is specified when the first actuating drive is actuated than when the second actuating drive is actuated.
